(19) United States
(12) Patent Application Publication
(10) Pub. No.: US 2009/0205142 A1
(43) Pub. Date: Aug. 20, 2009

(54) Process for Retanning Leather Using Hollow Microspheres

(76) Inventors: Otto Vorländer, Hilchenbach (DE); Werner Zeyen, Kürten (DE); Jürgen Reiners, Leverkusen (DE); Dietrich Tegtmeyer, Bergisch Gladbach (DE)

Correspondence Address: LANXESS CORPORATION, 111 RIDC PARK WEST DRIVE, PITTSBURGH, PA, 15275-1112, US

(21) Appl. No.: 12/086,553

(22) PCT Filed: Sep. 17, 2007
(86) PCT No.: PCT/EP2007/059800

§ 371 Date: Feb. 3, 2009

(30) Foreign Application Priority Data
Oct. 11, 2006 (DE) 102006048044.9
Mar. 9, 2007 (DE) 102007011555.7

(51) Int. Cl. C14C 3/06; C14C 3/02

(52) U.S. Cl. 8/94.2; 8/94.27; 8/94.19 R

(57) ABSTRACT

A process for retanning leather has been found, which is characterized in that
a) a tanned leather is treated in aqueous liquor in the presence of hollow microspheres filled with blowing agent,
b) the leather obtained according to a) is dried after further optional retanning steps and
c1) treated with steam at 80 to 120° C., in particular at 80 to 100° C., or
c2) with infrared radiation having a wavelength of 0.7 to 100 μm,
it also being possible for a finishing step b1) and/or a milling step b2) to follow at a time after the drying step b).

The invention relates to a process for retanning leather, leathers produced thereby and mixtures of hollow microspheres and chrome tanning agents or synthetic tanning agents and their use.

### PRIOR ART

Hollow microspheres have now been described in a variety of ways in connection with leather too. Thus, they are suitable, for example, superficially in the finishing of the grain side or flesh-side coating or are used as a retanning agent, introduced in the aqueous retanning step.

In DE 202006005330 U1, for example, leathers are coated with a hollow microsphere dispersion on the grain side and the hollow spheres are expanded after solidification of the dispersion with superheated steam at atmospheric pressure (i.e. max. 100° C.). Leather thus produced has a nubuck-like surface which has advantages with regard to the shrinkage behaviour and the hardening of the leather during the formation of the foam structure. What is disadvantageous, however, is that the foam structure is formed only on the surface and the leather retains its original thickness and the process is suitable only for filling depressions in the grain layer. The water absorption of the leather is not changed as such and the water vapour permeability is influenced substantially by the thickness of the finished layer.

In DE 10218076 B4, the foam finish is effected with hollow microspheres on the flesh side with subsequent treatment with hot air above 280° C. for expansion of the hollow spheres. A cushioning effect is to be achieved by expansion of individual leather fibre bundles present on the surface of the flesh side. What is disadvantageous, however, is that the hollow microspheres are present only on the surface on which a foam structure is formed on expansion of the hollow microspheres. No hollow microspheres are present in the interior of the leather. The high temperatures used for expansion of the hollow microspheres can destroy the foam structure and lead to shrinkage of the leather.

In U.S. Pat. No. 5,368,609, hollow microspheres are introduced into the leather in an aqueous retanning step in the drum. The expansion of the hollow spheres is effected with hot water at 70 to 90° C. in the drum or during the air drying. Other methods of drying, such as, for example, hot air, ironing over the hot plate or by superheated steam are also indicated, the hot air having the disadvantages described above, the hot plate resulting in only partial expansion of the hollow spheres owing to the high opposite pressure and superheated steam having proved to be harmful for the foam structure and the leather. However, the preferably used expansion processes also lead to leathers which are still capable of being improved with regard to the desired properties, such as softness of the leather, greater increase in thickness in combination with reduced water absorption, very good water vapour permeability and tensile strength.

EP-A 1 279 746 describes the basic use of hollow microspheres for introduction into leather in the aqueous retanning step. The expansion can then be effected in various ways, for example by means of microwaves, oven treatment, ironing (hot plate), IR heat or steam treatment, a temperature of 100 to 130° C. preferably being used and only the oven treatment and ironing (hot plate) being described by way of example. The steam treatment in this temperature range will correspond to the use of superheated steam, the disadvantages of which have already been described above. Disadvantages of the oven treatment and of the hot plates are likewise described above.

However, the leathers obtained in this manner still have disadvantages in use. Thus, for example, the cavities are not completely filled. The expansion, by means of ironing, of the hollow microspheres introduced into the fibre network, as proposed in EP-A 1279746, leads to a compaction of the leather, the softness suffering as a result. Furthermore, the expansion of the capsules is very different over the total cross section. The tensile strength of leather decreases as a rule with decreasing density. According to the prior art, the retanning agents used for improving the firmness of leathers lead to heavy leathers. A weight saving is of interest, for example, in the case of automotive upholstery leathers or leathers for aircraft seats, but also in the case of shoe upper leathers.

It was an object of the present invention to provide leathers which do not have said disadvantages and in particular have a fibre structure which is completely filled with hollow microspheres, leads to a large volume increase of the leather of in particular more than 50% by weight, based on the initial thickness of the substrate (in leather production, the reference point is the shaved thickness of the wet blue used), and, in spite of the reduced density due to the incorporation of the hollow microspheres, imparts increased tensile strength and high softness and little loose-grained character to the leathers. To improve the variety and improve the cutting yield in leather production, it is furthermore desired also to use very thin splits, for example having a thickness of less than 1 mm, and to produce therefrom leathers which are also suitable for high-quality automotive leathers.

A process for retanning leather has now been found which is characterized in that
a) a tanned leather is treated in aqueous liquor in the presence of hollow microspheres filled with blowing agent,
b) the leather obtained according to a) is dried after further optional retanning steps and
c1) treated with steam at 80 to 120° C. or
c2) with infrared radiation having a wavelength of 0.7 to 100 μm,
it also being possible for a finishing step b1) and/or a milling step b2) to follow at a time after the drying step b).

The time of the optional steps b1) and b2) is after the drying step b). This means that this may also be after the expansion step c). In this context, finishing step b1) is understood as meaning the application of a finished layer (bottoming) as well as the subsequent application of a top coat. However, these need not necessarily be steps directly following one another. If appropriate, a milling step b2) and/or an expansion step c) may also be present between the application of the bottoming and the top coat.

The tanned leather used in the retanning in step a) comprises both a fully tanned leather (i.e. a leather whose shrinkage temperature cannot be further increased) and a pretanned leather (i.e. a leather whose shrinkage temperature can still be increased by further tanning). For example, chrome-tanned (wet blue) leather, leather pretanned and retanned without chromium and vegetable-pretanned leather can be used as such. Leather containing mineral tanning agent or leather free of mineral tanning agent is preferred.

The hide of animals such as, for example, cattle, pig, goat, sheep, horse, kangaroo, yak, water buffalo, zebu and related animal species, can be used for the tanning. Cattle leather is preferred. The process is also suitable for improving varieties which for histological reasons have a very loose fibre structure.

The tanned leather used preferably has a shrinkage temperature of 65 to 105° C., preferably 90 to 102° C. Leathers having a low shrinkage temperature are preferably used when a part of the tanning agent, such as, for example, the chrome tanning agent, is used for further increasing the shrinkage temperature in the retanning step.

The tanned (i.e. also the pretanned) leather used is preferably shaved to a desired thickness and introduced into an apparatus customary in a tannery, the drum (closed drum rotating about an axis, which is made, for example, of wood or stainless steel), mixer (appearance similar to a concrete mixer on a lorry) or Y-drum (drum having a Y subdivision present in the drum) being preferably used as customary units in the tannery.

The shaved thickness of the tanned leather used is preferably greater than 0.5 mm, in particular from 0.8 to 5.0 mm.

The hollow microspheres preferably contain, as blowing agent, a liquid which has a boiling point which is not above the softening temperature of the shell of the hollow microspheres. Hydrocarbons, such as n-butane, isobutane, n-pentane, neopentane, isopentane, hexane, isohexane, heptane, octane, cyclopentane, cyclopentene, 1-pentene, 1-hexene, etc, are particularly suitable. Hydrocarbons which have a boiling point of less than 60° C. at atmospheric pressure are very particularly preferred. A particularly preferred blowing agent liquid in the interior of the hollow microspheres is isobutane. Chlorine or fluorine-containing compounds are also possible but not preferred. It is also possible to use blowing agents that are generated in situ on increasing the temperature, for example by chemical reactions, in particular by formation of gases: such blowing agents are, for example, azoinitiators known as polymerization initiators (such as 2,2′-azobisisobutyronitrile, AIBN), hydrogen peroxide, persulphates, percarbonates or CO₂-eliminating compounds, such as carbonates or bicarbonates. The blowing agent comprises as a rule 1 to 40% by weight of the total weight of the hollow microspheres.

Suitable hollow microspheres are in particular those having a diameter of 1 to 200 μm, preferably of 1 to 80 μm, particularly preferably 5 to 40 μm.

The hollow microspheres have a shell and an interior. The shell is preferably composed of an organic polymer or copolymer. Monomers suitable for the synthesis of the shell of the hollow microspheres are in particular monomers containing nitrile groups, such as acrylonitrile, methacrylonitrile, fumaronitrile and crotononitrile, acrylates or methacrylates, such as ethyl acrylate, methyl acrylate, methyl methacrylate, isobornyl methacrylate and hydroxyethyl methacrylate, vinyl halides, such as vinyl chloride and vinylidene chloride, vinyl esters, such as vinyl acetate and vinyl formate and styrene and substituted styrene compounds. In the synthesis of the shell, it is also advantageous to use polyunsaturated compounds which serve as crosslinking agents. The amount of such crosslinking agents is usually 0.1 to 2% by weight, based on the sum of all comonomers. Suitable polyunsaturated compounds are, for example, allyl methacrylate, ethylene glycol dimethacrylate, diethylene glycol dimethacrylate, triethylene glycol dimethacrylate, polyethylene glycol dimethacrylate, trimethylolpropane trimethacrylate, pentaerythrityl tetramethacrylate, bis(methacryloyloxymethyl)tricyclodecane and the corresponding diacrylates, divinylbenzene, etc.

Polymers and copolymers which are composed of vinylidene chloride, acrylonitrile and (meth)acrylate monomers, and mixtures thereof, are particularly preferred. Polyurethanes or polyurethane ureas are also suitable as wall material.

The thin shell particularly preferably consists of a copolymer of more than 75% of polyvinylidene chloride and of less than 25% of polyacrylonitrile. A liquid which has a boiling point of less than 60° C. is preferably present in the interior. Isobutane is used as a preferred blowing agent.

Hollow microspheres are commercially available. The Expancel® hollow microspheres from Akzo may be mentioned as exemplary hollow microspheres.

A distinction is made between unexpanded and expanded hollow microspheres.

The expanded capsules are preferably those which are obtained from the unexpanded capsules after heat treatment and cannot be substantially further expanded by a further heat treatment without being destroyed. The preferred diameter of the unexpanded hollow microspheres is 1 to 80 μm, preferably 5 to 40 μm. The preferred diameter for the expanded capsules is 10 to 160 μm, in particular 15 to 80 μm.

Hollow microspheres which can be expanded are preferably used, the starting point of the expansion being in the temperature range from 30 to 130° C., in particular 65 to 100° C.

The hollow microspheres are preferably used in an amount of 0.5 to 30% by weight, preferably 1 to 15% by weight, in particular 2 to 8% by weight, based on shaved weight.

The step a) of the process according to the invention is carried out in aqueous liquor, the liquor ratio (leather-to-water) preferably being 0 to 1000% by weight (based on shaved weight).

Step a) is preferably effected at a temperature of 20 to 70° C., in particular at 30 to 60° C. A pH of 2.0 to 10.0 is preferably employed. The pH range from 3 to 8 is very particularly preferred for the retanning step a).

In addition to the hollow microspheres, further additives customary for retanning can also be concomitantly used in step a). For example, dyes, synthetic tanning agents, resin tanning agents, vegetable tanning agents, polymer tanning agents based on acrylate copolymers, softening retanning agents based on polyamidocarboxylic acids (such as, for example, LEVOTAN® L) or based on esters of polycarboxylic acids and linear or branched polyether polyols, fatliquoring agents and chromium, aluminium or zirconium compounds may be mentioned as such. Binders, i.e. film-forming polymers, can likewise be used but are not preferred. Suitable binders are, for example, natural casein, butadiene copolymers, (meth)acrylate polymers (so-called polyacrylates) polyurethanes. The content of binders is preferably less than 5% by weight, preferably less than 2% by weight, based on the shaved weight.

The hollow microspheres are preferably added as a solid or in the form of an aqueous slurry in the retanning step a). A mixture containing hollow microspheres and a chrome tanning agent and/or a synthetic retanning agent is particularly preferred. Such a mixture preferably contains
A) 1.0 to 20% by weight of hollow microspheres which contain a blowing agent, in particular a liquid having a boiling point of less than 60° C. at atmospheric pressure, and
B) 1.0 to 20.0% by weight of chrome tanning agent and/or
C) 1.0 to 20.0% by weight of synthetic tanning agents.

Suitable chrome tanning agents are, for example, chromium sulphate tanning agents and complex chromium tanning agents comprising masking/buffering additives.

The abovementioned additives mentioned for the retanning step and water may be present as further constituents.

Suitable synthetic tanning agents are, for example, the condensates known per se to the person skilled in the art and based on aromatic compounds, such as phenol, naphthalene, ditolyl ether, phenolsulphonic acid, naphthalenesulphonic acid, ditolyl ether sulphonic acid, dihydroxydiphenyl sulphone and formaldehyde, it being possible to use further compounds reactive towards formaldehyde, such as urea or substituted urea, as raw materials.

It is particularly preferable to use the hollow microspheres in an aqueous formulation as a slurry which also contains the abovementioned auxiliaries, in particular chromium sulphate and/or synthetic tanning agent and optionally further auxiliaries.

Auxiliaries are, for example, customary products for retanning, such as bases and acids, dyes, fatliquoring agents and water repellents. Such products are commercially available and known per se to the person skilled in the art.

The running time in the drum for the use of the hollow microspheres is preferably 10 to 200 minutes, the hollow microspheres penetrating into the leather cross section and filling the pores in the fibre network to an extent of more than 90%. In particular, the hollow microspheres penetrate into the leather to directly below the grain layer.

The retanning step a) in which the hollow microspheres are applied can preferably be followed by further steps forming part of the retanning, such as, for example, neutralization, optionally retanning with synthetic, vegetable retanning agents or the abovementioned polymer tanning agents, optionally followed by dyeing, fatliquoring and final fixing, preferably with formic acid. Furthermore, surface dyeing with further fixing, preferably with formic acid, is possible.

After these procedures forming part of the retanning in the drum, the leathers are usually prepared by a mechanical hydroextraction process for the various drying methods, such as, for example, clamped, vacuum and suspended drying, and the drying is carried out.

The drying in the context of step b) of the process according to the invention is generally effected at a temperature of 30 to 70° C. The leather is preferably dried to a relative moisture content of 8 to 50% by weight, in particular of 8 to 25% by weight, preferably of 10 to 20% by weight. The dried leathers are preferably conditioned and staked. Before the expansion of the microcapsules, the leathers should in each case have a relative leather moisture content of 8 to 25% by weight, preferably 10 to 20% by weight relative leather moisture content or should be adjusted to the corresponding water content, if appropriate, by moistening or conditioning in a corresponding conditioning chamber. In the case of subsequent infrared treatment, the leather moisture content is preferably 20 to 50% by weight.

Where a finish is additionally to be applied in a separate step b1) to the dried leather obtained after step a), a bottom formulation customary in finishing technology can now be applied by the customary application techniques, preferably by spraying, in the customary amount to the crust leather and then dried and embossed. Thereafter, a top coat formulation customary in finishing technology is applied to the bottomed and embossed leather and then dried.

The products customary for the preparation of the bottom and top coat formulations, such as binders, crosslinking agents, pigments, levelling agents, additives, etc, are known per se to the person skilled in the art and are commercially available products.

Where the leathers are milled in an additional step b2), the leathers are preferably transferred to a milling drum under customary conditions which are generally known to the person skilled in the art and are milled until the desired optical and haptic properties are achieved. The milling process is usually carried out with the crust leather, with the bottomed leather or with the bottomed and embossed/ironed leather or with the finished final leather already provided with a top coat.

The expansion of the hollow microspheres embedded in the leather is carried out in the process according to the invention preferably at the stage of the crust leather (after step b)), after application of the bottoming (after b1)) or after application of the top coat (after b1)). Stepwise expansion at a plurality of points is also possible.

If no finish is applied the expansion is preferably carried out after step b) at the stage of the crust leather.

If the leather is to be milled (step b2)), the expansion is effected before or after the milling process, but particularly preferably after the milling.

If a finish is applied to the leather (step b1)) and the leather is additionally subjected to a milling process (step b2)), the milling process is preferably effected after the retanning at the stage of the crust leather or at the stage of the bottomed, optionally embossed/ironed leather. In these cases, the expansion of the hollow microspheres is particularly preferably carried out as the last step either directly after the milling of the crust leather or after completion of the finishing steps (b1).

For subsequent expansion of the hollow microspheres in step c), the leather is treated with steam at a temperature of 80 to 120° C., preferably of 80 to 100° C., for the case c1). Optimum values are achieved if the steam acts on the retanned leather over a period of less than 7 seconds, preferably of less than 3 seconds. It has been found that if such a steam briefly comes into contact at atmospheric pressure or virtually atmospheric pressure—i.e. let down, preferably below an excess pressure of less than 0.1 bar—with the leather retanned with hollow microspheres, said steam spontaneously results in the expansion of the hollow microspheres, without adversely affecting the properties of the leather thereby. The leather is preferably penetrated by the hot steam. During this process, no moisture is withdrawn from the leather but rather supplied to it, with the result that hardening and shrinkage of the leather are prevented. The hollow microspheres thus expanded are also better formed when those which form by application of pressure and heat or by hot air treatment in the known processes and are not destroyed especially with the use of steam at atmospheric pressure in said manner. On application of steam which contains no water but is present as 100% steam, the danger of destruction of the hollow microspheres by overheating is very high and the leather may shrink. In these cases, the increase in the leather volume would be substantially smaller and the leather would not be optimum with regard to the hand and the water absorption.

The steam apparatus for producing the hot steam (superheated steam) expediently has at least one superheated steam container which is connected to superheated steam outlet openings, directed towards the leather surface, in particular to outlet nozzles or slots, via the openings of which the superheated steam is supplied to the leather from the grain and/or the flesh side. In an expedient embodiment, the superheated steam container consists of at least one pipe having a round or polygonal cross section, which is provided with the superheated steam outlet openings. It has proved to be advantageous if this pipe is formed so as to be meander-like, the individual sections preferably running transversely to the transport direction of the leather (i.e. of the running direction of the conveyor belt by the aid of which the leather is moved past the superheated steam outlet openings in the production process), and is connected at its two ends to a superheated steam source so that the steam is circulated in the pipe and hence a cooling is prevented. A low steam pressure of less than 5 bar, preferably less than 2 bar, in the pipe is sufficient here.

It is also possible to keep the superheated steam apparatus movable and to move it accordingly relative to the leather surface, it being possible for the directional movement to be linear, circular or elliptical or to be a swinging movement, with the proviso that the outlet openings do not come into direct contact with the leather surface. Combinations of the movements are also advantageous.

It is advantageous if a heat source is provided in the superheated steam container, preferably in a wall thereof and in particular in the wall surrounding the superheated steam outlet openings. This heat source reduces condensation if, as a result of said heat source, the temperature in the environment of the superheated steam outlet openings is lower than the superheated steam temperature.

However, this heat source can also be used for forming the superheated steam in the superheated steam container itself if in fact only water is fed initially to this superheated steam container and the superheated steam is formed from this water in situ by supplying heat.

The heat source may consist of electrical heating wires which, for example, are embedded in the wall of the superheated steam container or may be formed from pipes through which heated oil flows and which can be provided in the form of heating coils in the case of formation of the superheated steam in the interior of the superheated steam container itself.

However, it is also possible to provide an arrangement in which the superheated steam apparatus is in the form of a superheated steam container which surrounds the transport apparatus and to which superheated steam is fed via a superheated steam source or in which the superheated steam is formed in situ so that the leather present on the transport apparatus comes into contact, during the further movement in this superheated steam container, with the superheated steam that is present therein. Here, the superheated steam apparatus is expediently arranged adjacent to a revolving transport apparatus supporting the leather, so that the leather which is moving past the superheated steam apparatus continuously comes into contact with the superheated steam.

According to the invention, however, it is also possible to form the superheated steam directly on the surface of the leather. In this case, the superheated steam apparatus has at least one hot water or wet steam container which is connected to outlet openings directed towards the leather, and a heat supply apparatus arranged after the hot water or wet steam container, viewed in the transport direction. The hot water or the wet steam first wets the surface of the leather and is subsequently converted by the heat supply apparatus into superheated steam, with the result that substantially the same effect as in the case of direct supply of the superheated steam is achieved. In this case, however, the energy consumption is greater than in the case of direct supply of superheated steam. A suitable heat supply apparatus is, for example, an infrared radiator, preferably an infrared dark radiator.

The superheated steam apparatus from DE 20 2006 005 330 U1, in particular from FIG. 3, and the installation thereof in one of the plants described there are preferred, the disclosure of which is also intended to be the subject matter of this application. Of course, the application units for the plastic dispersions are not necessary for the purpose of the process according to the invention.

In the subsequent expansion of the hollow microspheres in step c), the leather is, for case c2), treated with infrared radiation having a wavelength of 0.7 to 100 μm, in particular with infrared dark radiation having a wavelength of 2 to 10 μm. A distance between the leather surface (grain or flesh side) and the radiating surface of the IR radiator of 45 to 220 mm is preferably maintained.

The treatment is preferably effected for a period of less than 30 sec, preferably less than 20 sec. The leather is preferably heated to a temperature of 90 to 115° C.

Through uniform heat supply in all regions of the leather and in particular also in the deeper regions, the use of such an IR radiator results in the expansion of the hollow microspheres, and a foam structure which is not subjected to a shrinkage process forms in these regions too. The IR radiator is preferably in the form of a panel radiator. It has proved to be expedient if the infrared radiator is provided after a drying tunnel through which the leather runs, viewed in the transport direction of the leather, so that the leather filled with hollow microspheres has already been dried and already has a temperature of 65 to 80° C. In this case, heating by means of infrared radiation to a temperature of 105° C. can be effected in less than 12 sec.

### Advantages:

The leathers thus obtained have a uniform thickness, improved tensile strength, more uniform density through selective, particularly pronounced filling of the loose regions in the total leather cross section. At the same time, the softness of the leathers is improved compared with an expansion under pressure, and the loose-grained character is substantially less. It is furthermore possible virtually completely to fill grain defects and the cavities of the hair root sheath to the extent achievable by means of this process and of the use of the corresponding hollow microsphere diameter. It is therefore possible also to process low-quality raw material, in particular that having many defects in the grain layer, to give a high-quality leather without separate process steps being required in leather production. A particular feature of the leathers is that the large cavities which are achievable by means of this process and of the use of the corresponding hollow microsphere diameter are filled to an extent of more than 90% with hollow microspheres and these are anchored permanently in the substrate as a result of the expansion.

Water vapour permeability and water absorption of the leathers produced according to the invention are substantially improved. In particular, the density of the leathers is dramatically reduced owing to the large volume increase. The leathers produced according to the invention have improved tensile strength in comparison with the control without hollow microspheres and leathers in which the hollow microspheres do not penetrate below the grain layer and, covered by others, are only incompletely expanded.

The invention furthermore relates to leathers obtainable by the process according to the invention.

The leather contains expanded hollow microspheres incorporated into the fibre network and has an improved tensile strength compared with an untreated leather, in spite of the lower density. The static water absorption (determined by the Kubelka method: by means of introduction of a leather sample into a water bath for a defined time span, for example of 2, 8 and/or 24 hours, and determination of the weight increase in %) is substantially reduced, which represents a considerable advantage.

The invention furthermore relates to the use of the leather according to the invention, in particular as buffed or full-grain leather or as split leather, for automotive, furniture, glove, bag or upper leather articles.

The use for leather fibre material, which contains a mixture of chromium-free or chromium-containing leather fibres, dyes, synthetic or vegetable tanning agents and binders, such as, for example, butadiene and acrylates, is also possible.

The invention furthermore relates to a mixture containing
A) 1 to 20% by weight of hollow microspheres which contain a blowing agent, in particular a liquid having a boiling point of less than 60° C. at atmospheric pressure, and
B) 1 to 20% by weight of a chrome tanning agent, preferably of a basic chromium sulphate.

The preferred embodiments for the hollow microspheres, blowing agents and chrome tanning agents are the abovementioned ones.

The invention furthermore relates to a mixture containing
A) hollow microspheres which contain a blowing agent, in particular a liquid having a boiling point of less than 60° C. at atmospheric pressure, and
B) a neutralization tanning agent.

Both mixtures according to the invention preferably contain less than 5% by weight, in particular less than 2% by weight, of a binder.

Chrome tanning agents, which can be used as powder or in liquid form, are particularly preferred, in particular basic chromium sulphates having a basicity between 20 and 70% and a chromium content, determined as Cr₂O₃, between 10 and 40%. Tanning agents such as CHROMOSAL® B and CHROMOSAL® B liquid (Lanxess Deutschland GmbH) may be mentioned by way of example.

Neutralization tanning agents are preferably aromatic compounds, such as phenolic sulphonic acids or naphthalenesulphonic acid or condensates thereof with formaldehyde and mixtures thereof with carboxylic acids, dicarboxylic acids and polycarboxylic acids, these products having buffering properties and are used in retanning, and, for example, particularly level dyeings being permitted by the neutralizing effect thereof over the total leather cross section. Polymer retanning agents based on modified polyamidocarboxylic acids having softening and filling properties or softening and/or filling polyacrylate-based polymer retanning agents may furthermore be used in proportionate amounts. Such products are commercially available and are known to persons skilled in the art. For example, TANIGAN® PAK-N, TANIGAN® PR, TANIGAN®& SR, TANIGAN® PAK, LEVOTAN® L, LEVOTAN® C, LUBRITAN® GX, LUBRITAN® AS, LUBRITAN® TG, etc. (Lanxess Deutschland GmbH) may be mentioned as suitable retanning agents.

The invention furthermore relates to the use of the mixture according to the invention for retanning leather.

A possible finishing can be effected before, during or after the expansion.

A possible milling process can be effected before, during or after the expansion. It is particularly preferable to carry out the milling process before the expansion.

Surprisingly, it has been found that, even without further process steps, such as, for example, buffing of the surface in the case of grain defects, the leathers have a uniform appearance and also meet very high requirements with regard to the fastnesses. Furthermore surprising is that there is virtually complete filling of all achievable cavities, in particular to an extent of more than 90%. The proportion of cavities filled with hollow microspheres can be controlled by the amount used in combination with the conditions for the expansion. The process according to the invention is suitable for converting even low-quality raw material into elegant, uniform leather surfaces since the loose parts of the hide material are filled to a particularly high degree or experience greater expansion of the hollow microspheres than the parts with fibres closer together. The process according to the invention is simple and manages with a minimum of chemicals. Firm but soft leathers having a larger volume, which surprisingly have improved tensile strength at lower density, are thus made available. The water absorption of the leathers is reduced, which has a considerable advantage, and water repellent leathers, for example shoe upper leathers, are also made available from raw materials which would otherwise be completely unsuitable for this purpose. The volume increase can be controlled via the amount used and the type of hollow microspheres, the concomitantly used auxiliaries B) and C) and the expansion conditions of the hollow microspheres.

Where finishing is effected as operation b1), the following expansion of the hollow microspheres can be carried out before, during or after the finishing. It is preferable to carry out the finishing process before or after the expansion of the hollow microspheres. The optical properties of the surface can be influenced via the type of expansion.

Where a milling process is effected as operation b2), the subsequent expansion of the hollow microspheres can be carried out before, during or after the milling. It is preferable to carry out the milling process before the expansion of the hollow microspheres. The optical properties of the surface can be influenced by the type of expansion. In particular, different results can be achieved depending on whether the energy supply for the expansion is effected from the grain side or the flesh side. In particular, the visual impression, for example whether a rough or a smooth surface is formed, can be influenced in the process according to the invention by the type of expansion. In the expansion according to step c1) from the flesh side, for example, a rough, microstructured surface is achieved. In the expansion according to step c1) from the grain side, as a rule a very smooth surface is obtained.

It was surprisingly found that it is particularly advantageous to combine the optional steps b1) and b2) with one another. It was furthermore found that, particularly in this embodiment, the procedure for the expansion of the hollow microspheres influences the properties of the leather obtained. In particular, a rough surface can be produced in the case of a leather exposed with the flesh side to the expansion apparatus (i.e. the steam apparatus described above or the IR radiator). If, on the other hand, the expansion is effected from the grain side by ensuring that the grain side of the leather faces said steam apparatus for the expansion, a smooth surface is as a rule produced.

In a particularly preferred embodiment, it is furthermore possible to carry out the expansion after the embossing and milling of the bottomed leathers and to provide the leathers thus obtained with a final finish as a top coat, the optical effect achieved being permanently fixed.

An embodiment in which a milling process b2) is effected after retanning and drying (step b)) and the leather is then expanded according to step c1) or c2) is furthermore particularly preferred. If appropriate, a small amount of a top coat can also be sprayed as a final finish for improving the fastnesses.

With the process according to the invention, it is also possible to control the surface structure and roughness by the amounts of hollow microspheres used in the wet region. For the effect, it is particularly advantageous, however, to fill the cavities in the fibre structure in the retanning step a) as uniformly as possible and as completely as possible with hollow microspheres.

### EXAMPLE 1

### According to the Invention

Half a cattle hide (wet blue) was shaved to a thickness of 1.2 mm (measured using a leather thickness meter). The shaved weight, which was used as a reference parameter for the additions of the chemicals, as usual in leather production, was determined by weighing.

The retanning process was carried out as follows:

### I. Production of a Tanned Leather

### First Process Step (Preparation):

A wet blue half is placed in a V2A steel retanning drum which is provided with a double-wall drum casing with water enclosed therein, which is electrically heated; 300% of water at a temperature of 40° C. (all stated percentages are based in each case on the shaved weight, even in the process steps described below) and 0.3% of 85% strength formic acid (for this, 1 part of formic acid was prediluted with 10 parts of water at 20° C.) are then added. The running time in the rotating drum (rotational speed 15-18 revolutions per minute) with heating set to a temperature of 40° C. was 20 minutes. The pH was 3.0. The liquor was discharged through the perforated drum cover, which is present in the drum casing, while the drum was rotating. The wet blue half remained in the drum for the next step.

### Second Process Step:

150% by weight of water at a temperature of 40° C. was added. The first part of the neutralization was then carried out by introducing 4% of a neutralization tanning agent having a strong neutralization and buffer effect (TANIGAN® PAK-N liquid from Lanxess Deutschland GmbH) into the drum. The running time in the rotating drum was 30 minutes at a heating setting of 40° C. 1.5% by weight of sodium carbonate (techn.) were then added. The running time in the rotating drum was 30 minutes.

### Third Process Step:

4.0% by weight of a commercial fatliquoring agent (such as Lipodermlicker A1 (BASF AG, Ludwigshafen)) were added for preliminary fatliquoring. The running time in the rotating drum was 15 minutes.

### Fourth Process Step:

4.5% by weight of a polymer tanning agent based on a modified polyamidocarboxylic acid having a softening and filling effect (such as LEVOTAN L, Lanxess Deutschland GmbH, Leverkusen) were then added. The subsequent running time in the rotating drum was 30 minutes.

### II. Process Step According to the Invention

### Step a)

8% of a product mixture which consists of 50 parts by weight of a self-basifying chromium sulphate tanning agent having a chromium oxide content of about 17% and 50 parts by weight of unexpanded hollow microspheres based on a polyvinylidene chloride copolymer (such as Expancel 820 SL 40) is added to the tanned leather described under I. in the drum. The hollow microspheres have a diameter of 2-30 μm in the unexpanded state and have a starting temperature for the expansion of 75-90° C. The running time in the rotating drum was 90 minutes (heating setting 40° C./pH at the end about 4.8).

Thereafter, the drum rotated at a rotational speed of 15 revolutions per minute, in each case with rotation for 10 minutes and a standing time of 20 minutes in constant alternation for 16 hours.

The second part of the neutralization was then effected with the use of 1% of TANIGAN PAK-N liquid with a running time of 10 minutes and addition of 0.4-0.7% by weight of technical-grade sodium bicarbonate for 30 minutes (heating setting 40° C./pH at the end about 5.9 to 6.4), followed by the operations of washing, retanning, dyeing, acidification, washing, overdyeing, acidification and washing.

The leather was stored on a horse.

### Step b)

On the next day, the leather was set out, clamped while wet and dried in a toggle frame dryer for 2 to 8 hours with introduction of low-pressure steam at 40-70° C. Suspended drying and conditioning overnight, staking on the staking machine and subsequent milling in a milling drum were then effected. The leather had a leather moisture content of 18%.

By treatment with steam at a temperature of 95° C. at atmospheric pressure by means of the superheated steam apparatus as described in DE 20 2006 005 330 U1, the expansion of the hollow microspheres was effected and a soft leather having outstanding firmness, low density and reduced water absorption was obtained.

Leather thickness: 1.7 mm; density: 0.59 g/cm³, tensile strength: 16 daN. Static water absorption (Kubelka) after 2 hours: 59%, after 24 hours: 68%.

### EXAMPLE 2

### Comparative Experiment

As a comparison, the process step II)a) described in example 1 was modified as follows:

### Step a)

30% of water at 40° C. and 4% of a self-basifying chrome tanning agent having a chromium oxide content of about 17% are added to the tanned leather described according to Example 1 under point 1. (which is used here as comparative material) in the drum. The running time in the rotating drum was 60 minutes (heating setting 40° C./pH at the end about 4.8).

Thereafter, the drum was rotated at a rotational speed of 15 revolutions per minute, in each case rotation for 10 minutes and a standing time of 20 minutes in constant alternation for 16 hours.

The second part of the neutralization was then effected with the use of 1% of TANIGAN PAK-N liquid with a running time of 10 minutes and addition of 0.4-0.7% by weight of technical-grade sodium bicarbonate for 30 minutes (heating setting 40° C./pH at the end about 5.9 to 6.4), followed by the operations of washing, retanning, dyeing, acidification, washing, overdyeing, acidification and washing.

The leather was stored on a horse.

### Step b)

On the next day, the leather was set out, clamped while wet and dried in a toggle frame dryer for 2 to 8 hours with introduction of low-pressure steam at 40-70° C. Suspended drying and conditioning overnight, staking on the staking machine and possibly subsequent milling in the milling drum were then effected.

The leather did not change as in Example 1 even after the steam treatment but remained thin. In addition, it becomes hard in some places as a result of the steam treatment and has a rough surface.

Leather thickness: 1.0 mm, tensile strength: 11 daN. Static water absorption (Kubelka) after 2 hours: 140%, after 24 hours: 180%.

### EXAMPLE 3

### According to the Invention

### Step a)

4% of unexpanded hollow microspheres based on a polyvinylidene chloride copolymer, such as Expancel® 820 SL 40, is added to the tanned leather described in Example 1 under point I in the drum. The hollow microspheres have a diameter of 2-30 μm in the unexpanded state and have a starting temperature for the expansion of 75-90° C. The running time in the rotating drum was 90 minutes (heating setting 40° C./pH at the end about 4.8).

Thereafter, the drum rotated at a rotational speed of 15 revolutions per minute, in each case with rotation for 10 minutes and a standing time of 20 minutes in constant alternation for 16 hours.

The second part of the neutralization was then effected: 1% of TANIGAN PAK-N liquid was added and a running time of 10 minutes was set; addition of 0.4-0.7% by weight of sodium bicarbonate (techn.) was then effected and a running time of 30 minutes (heating setting 40° C./pH at the end about 5.9 to 6.4) was set. This was followed by the operations of washing, retanning, dyeing, acidification, washing overdyeing, acidification and washing.

The leather was stored on a horse.

### Step b)

On the next day, the leather was set out, clamped while wet and dried in a toggle frame dryer for 2-8 hours with introduction of low-pressure steam at 40-70° C. Suspended drying and conditioning overnight, staking on the staking machine and subsequent milling in the milling drum were then effected.

The expansion of the hollow microspheres was effected by treatment with superheated steam at atmospheric pressure as in Example 1, and a soft leather having a low density (0.39 g/cm³) and a substantially reduced static water absorption compared with a leather without incorporated hollow microspheres (Kubelka: after 2 hours: 54%, after 24 hours: 67%) was obtained.

The volume increase of the leather compared with the leather from Example 1 was slightly more pronounced. The leather differs from Example 1 with respect to the hand.

### EXAMPLE 4

### According to the Invention

The procedure was as in Example 3, but with the following modification in step b)

### Step b)

On the next day, the leather was set out, clamped while wet and dried in a toggle frame dryer for 2-8 hours with introduction of low-pressure steam at 40-70° C. Suspended drying and conditioning overnight and staking on the staking machine were effected, without subsequent milling.

By treatment with superheated steam at atmospheric pressure as in Example 1, the expansion of the hollow microspheres was effected and a soft leather having a low density (0.39 g/cm³) and a substantially reduced static water absorption compared with a leather without incorporated hollow microspheres (Kubelka: after 2 hours: 54%, after 24 hours: 67%) was obtained.

The volume increase of the leather is unchanged compared with the leather from Example 3. The leather differs from Example 3 by a slightly less pronounced grain in combination with virtually the same pleasant hand.

1. Process for retanning leather, characterized in that
a) a tanned leather is treated in aqueous liquor in the presence of hollow microspheres filled with blowing agent,
b) the leather obtained according to a) is dried after further optional retanning steps and
c1) treated with steam at 80 to 120° C., in particular at 80 to 100° C., or
c2) with infrared radiation having a wavelength of 0.7 to 100 μm,
it also being possible for a finishing step b1) and/or a milling step b2) to follow at a time after the drying step b).

2. Process according to claim 1, characterized in that the hollow microspheres are filled with a liquid having a boiling point of less than 60° C. at atmospheric pressure, in particular with isobutane.

3. Process according to claim 1, characterized in that polymers and copolymers which are composed of vinylidene chloride, acrylonitrile and (meth)acrylate monomers, and mixtures thereof, are suitable as shell material of the hollow microspheres used.

4. Process according to claim 1, characterized in that the retanning a) is carried out in the presence of chrome tanning agents and/or synthetic retanning agents.

5. Process according to claim 1, characterized in that the step a) is carried out in the presence of chrome tanning agents.

6. Process according to claim 1, characterized in that the step a) is carried out in the presence of synthetic retanning agents.

7. Process according to claim 1, characterized in that the step a) is carried out in the presence of chrome tanning agents and synthetic retanning agents.

8. Process according to claim 1, characterized in that the expansion steps c1) or c2) are carried out before or after the steps b1) and/or b2).

9. Process according to claim 1, characterized in that the step c) is carried out with hot steam at 80 to 100° C.

10. Process according to claim 1, characterized in that the step c) is carried out with infrared radiation having a wavelength of 0.7 to 100 μm.

11. Leather obtained by the process according to claim 1.

12. Mixture containing
a) hollow microspheres filled with a blowing agent, in particular a liquid having a boiling point of less than 60° C. at atmospheric pressure, and
b) a chrome tanning agent.

13. Mixture containing
c) hollow microspheres which contain a liquid having a boiling point of less than 60° C. at atmospheric pressure, and
d) a synthetic retanning agent.

14. Use of the mixture according to claim 12 or 13 for retanning leathers.

15. Use of leather according to claim 11 as buffed or full-grain leather or as split leather for automotive, furniture, glove, bag and upper leather articles.
